(19) United States
(12) Patent Application Publication
(10) Pub. No.: US 2026/0021717 A1
(43) Pub. Date: Jan. 22, 2026

(54) FUEL CELL VEHICLE AND METHOD OF ALLOCATING POWER THEREOF

(71) Applicants: HYUNDAI MOTOR COMPANY, Seoul (KR); KIA CORPORATION, Seoul (KR)

(72) Inventors: Tae Woo Ryu, Hwaseong-si (KR); Jae Hwi Ko, Hwaseong-si (KR); Seong Yun Song, Hwaseong-si (KR)

(73) Assignees: HYUNDAI MOTOR COMPANY, Seoul (KR); KIA CORPORATION, Seoul (KR)

(21) Appl. No.: 19/173,007

(22) Filed: Apr. 8, 2025

(30) Foreign Application Priority Data
Jul. 22, 2024 (KR) 10-2024-0096628

(51) Int. Cl. B60L 50/75; B60L 58/12; B60L 58/16; B60L 58/40

(52) U.S. Cl. CPC B60L 50/75; B60L 58/12; B60L 58/16; B60L 58/40; B60L 2210/10

(57) ABSTRACT

Disclosed are a fuel cell vehicle and a method of allocating power thereof. The fuel cell vehicle includes a cell stack including a plurality of stacked unit cells, a battery, and a main controller configured to correct and vary a predetermined power allocation ratio using a power allocation correction factor in which a result of comparing a first state of health (SOH) of the cell stack with a second SOH of the battery is provided. Each of the predetermined power allocation ratio and the corrected power allocation ratio represents a power usage ratio of at least one of the cell stack or the battery.

This application claims the benefit of Korean Patent Application No. 10-2024-0096628, filed on Jul. 22, 2024, which is hereby incorporated by reference as if fully set forth herein.

### TECHNICAL FIELD

Embodiments relate to a fuel cell vehicle and a method of allocating power thereof.

### BACKGROUND

If the state of health (SOH) of a cell stack or a battery after a fuel cell vehicle has travelled a prescribed distance falls below the SOH provided (e.g., guaranteed) by the manufacturer of the fuel cell vehicle, the manufacturer replaces the cell stack or the battery free of charge.

In the case of conventional fuel cell vehicles, in order to supply total power used (e.g., required) to drive a load, a ratio of power that the cell stack supplies to the total power and a ratio of power that the battery supplies to the total power, e.g., a power usage ratio, may be set (e.g., fixed). Therefore, if any one power source among the cell stack and the battery degrades earlier than the other after travel of a prescribed distance, the SOH of the corresponding power source may fall below the provided (e.g., guaranteed) SOH thereof, and thus the manufacturer of the fuel cell vehicle may replace the corresponding power source (e.g., free of charge). When the SOH of any one power source among the cell stack and the battery falls below the provided (e.g., guaranteed) SOH thereof and thus the corresponding power source may qualify for replacement, the SOH of the other power source may be greater than the provided (e.g., guaranteed) SOH thereof, which may cause an imbalance in the power usage ratio. Therefore, it would be useful to address or prevent an imbalance.

### SUMMARY

Accordingly, embodiments are directed to a fuel cell vehicle and a method of allocating power thereof that substantially address one or more problems due to current limitations and disadvantages.

Embodiments provide a fuel cell vehicle and a method of allocating power thereof capable of making the degree of degradation of a cell stack and the degree of degradation of a battery (e.g., substantially) equivalent to each other.

The objects to be accomplished by the embodiments are not limited to the above-mentioned objects, and other objects not mentioned herein may be provided from the following description.

Additional objects and features of the disclosure will be set forth in part in the description which follows and in part may become apparent upon examination of the following or may be learned from practice of the disclosure. The objectives of the disclosure may be realized and attained by the structure in the written description and claims hereof as well as the appended drawings.

A fuel cell vehicle according to an embodiment may include a cell stack including a plurality of stacked unit cells, a battery, and a main controller configured to correct and vary a predetermined power allocation ratio using a power allocation correction factor in which a result of comparing a first state of health (SOH) of the cell stack with a second SOH of the battery is reflected, wherein each of the predetermined power allocation ratio and the corrected power allocation ratio may represent a power usage ratio of at least one of the cell stack or the battery.

In an example embodiment, each of the predetermined power allocation ratio and the corrected power allocation ratio may represent a ratio of first power to be output from the cell stack to total power used (e.g., required) by the fuel cell vehicle.

In an example embodiment, the fuel cell vehicle may further include a stack operating unit configured to output the first power corresponding to the corrected power allocation ratio from the cell stack in response to a first control signal and a battery management system configured to perform control in response to a second control signal such that second power obtained by subtracting the first power from the total power is output from the battery. The main controller may generate the first and second control signals in response to the corrected power allocation ratio.

In an example embodiment, the battery management system may obtain the second SOH of the battery using the current and voltage of the battery.

In an example embodiment, the main controller may include a first SOH calculation unit configured to obtain the first SOH of the cell stack using the current and voltage of the cell stack, an SOH comparison unit configured to subtract the first SOH from the second SOH to obtain an SOH difference, a first storage unit configured to store a power allocation correction factor for each SOH difference, a correction unit configured to correct a predetermined power allocation ratio for each SOH difference, representing a ratio of power to be output from each of the battery and the cell stack to the total power, using the power allocation correction factor corresponding to the SOH difference, and a control signal generator configured to generate first and second control signals corresponding to the corrected power allocation ratio.

In an example embodiment, the fuel cell vehicle may further include a second storage unit configured to store a power allocation map representing the predetermined power allocation ratio for the total power and each state of charge (SOC) of the battery, and the correction unit may read out the predetermined power allocation ratio from the second storage unit, may correct the predetermined power allocation ratio, and may update the power allocation map stored in the second storage unit using the corrected power allocation ratio.

In an example embodiment, the main controller may further include a calibration unit configured to calibrate the power allocation correction factor in accordance with a time period used (e.g., required) to change the power usage ratio.

In an example embodiment, the power allocation correction factor used in the correction unit may be stored in the first storage unit.

In an example embodiment, the power allocation correction factor used in the correction unit may correspond to a result of calibration by the calibration unit.

In an example embodiment, the fuel cell vehicle may further include a driving controller configured to measure traveling force used (e.g., required) for the fuel cell vehicle, an auxiliary controller configured to calculate the total power used (e.g., required) to drive a load so that the traveling force measured by the driving controller is reached and to provide information about the calculated total power to the main controller, and a direct current/direct current converter configured to convert the level of power output from the battery and to output power having the converted level.

According to another embodiment embodiment, a method of allocating power of a fuel cell vehicle may include obtaining a first SOH of a cell stack, obtaining a second SOH of a battery, obtaining an SOH difference by which the second SOH is greater than the first SOH, obtaining a power allocation correction factor corresponding to the SOH difference, correcting and varying a predetermined power allocation ratio using the power allocation correction factor, and supplying power corresponding to the corrected power allocation ratio to a load from each of the battery and the cell stack, wherein each of the predetermined power allocation ratio and the corrected power allocation ratio may represent a power usage ratio of at least one of the cell stack or the battery.

In an example embodiment, each of the predetermined power allocation ratio and the corrected power allocation ratio may represent a ratio of power to be output from the cell stack to total power used (e.g., required) by the fuel cell vehicle.

In an example embodiment, the SOH difference and the power allocation correction factor may be inversely proportional to each other.

In an example embodiment, obtaining the power allocation correction factor may include selecting the power allocation correction factor corresponding to the SOH difference using a factor map representing a power allocation correction factor for each SOH difference.

In an example embodiment, obtaining the power allocation correction factor may further include calibrating the power allocation correction factor selected from the factor map in accordance with a time period used (e.g., required) to change the power usage ratio.

In an example embodiment, the first SOH may be a ratio of the current maximum capacity of the cell stack to the maximum capacity at the beginning of life of the cell stack, and the second SOH may be a ratio of the current maximum capacity of the battery to the maximum capacity at the beginning of life of the battery.

The description of the present disclosure is exemplary and is intended to provide further explanation of the disclosure as claimed.

### BRIEF DESCRIPTION OF THE DRAWINGS

The accompanying drawings, which are included, provide an understanding of the disclosure and are incorporated herein, illustrate embodiment(s) of the disclosure, and together with the description provide the disclosure. In the drawings:

FIG. 1 is a flowchart of a power allocation method of a fuel cell vehicle according to an embodiment;

FIG. 2 is a graph of calibration of a power allocation correction factor;

FIG. 3 is a block diagram of a fuel cell vehicle according to an embodiment;

FIG. 4 is a block diagram showing an embodiment of the main controller shown in FIG. 3;

FIG. 5 is a graph of a method of obtaining a first state of health (SOH);

FIG. 6 is a block diagram showing another embodiment of the main controller shown in FIG. 3;

FIGS. 7A and 7B are graphs of the characteristics of a fuel cell vehicle according to a comparative example; and

FIG. 8 is a graph of the characteristics of the fuel cell vehicle according to the embodiment.

### DETAILED DESCRIPTION

The present disclosure is described more fully hereinafter with reference to the accompanying drawings, in which various embodiments are shown. The examples, however, may be embodied in different forms, and should not be construed as being limited to the embodiments set forth herein. Rather, the embodiments are provided to convey the scope of the disclosure.

When an element is referred to as being “on” or “under” another element, the element may be (e.g., directly) on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below,” are used (e.g., only) to distinguish between one subject or element and another subject or element, without (e.g., requiring or) involving any physical or logical relationship or sequence between the subjects or elements.

Herein, a power allocation method 100 of a fuel cell vehicle according to an embodiment will be described with reference to the accompanying drawings.

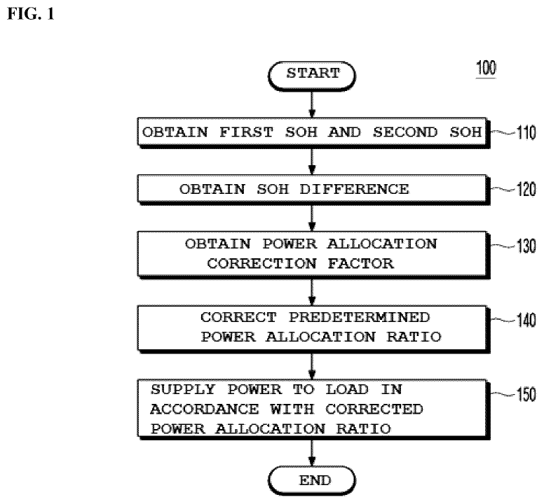

FIG. 1 is a flowchart of a power allocation method 100 of a fuel cell vehicle according to an embodiment.

The power allocation method 100 of a fuel cell vehicle according to the embodiment includes a step of obtaining the state of health (SOH) of a cell stack SOH1 (hereinafter referred to as a “first SOH”) and the state of health (SOH) of a battery SOH2 (hereinafter referred to as a “second SOH”, SOH2) (step 110).

The first SOH SOH1 refers to a ratio of the current maximum capacity of the cell stack to the maximum capacity at the beginning of life (BOL) of the cell stack, and the second SOH SOH2 refers to a ratio of the current maximum capacity of the battery to the maximum capacity at the BOL of the battery. The maximum capacity at the BOL of the cell stack refers to the maximum capacity of the cell stack before the cell stack is used after being manufactured, and the maximum capacity at the BOL of the battery refers to the maximum capacity of the battery before the battery is used after being manufactured.

The first SOH SOH1 is an indicator of the percentage (%) by which the life of the cell stack has been reduced from the original design life thereof, and the second SOH SOH2 is an indicator of the percentage (%) by which the life of the battery has been reduced from the original design life thereof.

After step 110, a value by which the second SOH SOH2 is greater than the first SOH SOH1, e.g., a SOH difference ΔSOH, is obtained using the following Equation 1 (step 120).

$$Δ SOH = SOH 2 - SOH 1 \qquad [ Equation 1 ]$$

After step 120, a power allocation correction factor corresponding to the SOH difference ΔSOH is obtained (step 130).

After step 130, a predetermined power allocation ratio is corrected and varied using the power allocation correction factor (step 140).

Each of the predetermined power allocation ratio and the corrected power allocation ratio may represent the power usage ratio of at least one of the cell stack or the battery.

For example, each of the predetermined power allocation ratio and the corrected power allocation ratio may represent a ratio of power to be output from the cell stack (hereinafter referred to as “first power”) to the total power used (e.g., required) by the fuel cell vehicle. In an example embodiment, a result obtained by subtracting the first power from the total power may represent a ratio of power to be output from the battery (hereinafter referred to as “second power”) to the total power.

According to one embodiment, the power allocation correction factor may be obtained by selecting a power allocation correction factor corresponding to the SOH difference using a factor map representing a power allocation correction factor for each SOH difference (step 130).

For example, Table 1 is an example of the factor map representing a power allocation correction factor K1 for each SOH difference ΔSOH.

TABLE 1

| ΔSOH[%] | 0 | 10 | 20 | 30 | 40 | 50 | 60 | 70 | 80 | 90 | 100 |
|---|---|---|---|---|---|---|---|---|---|---|---|
| K1 | 1 | 0.9 | 0.8 | 0.7 | 0.6 | 0.5 | 0.4 | 0.3 | 0.2 | 0.1 | 0 |

Referring to Table 1, the SOH difference ΔSOH and the power allocation correction factor K1 are inversely proportional to each other.

After step 130, the predetermined power allocation ratio may be corrected as shown in Equation 2 below using the power allocation correction factor K1 selected from the factor map (step 140).

$$CAR = K 1 \times AR \qquad [ Equation 2 ]$$

In Equation 2, AR is the predetermined power allocation ratio, and CAR is the corrected power allocation ratio.

According to another embodiment, the power allocation correction factor K1 selected from the factor map may be calibrated in accordance with a time period used (e.g., required) to change the power usage ratio (step 130). For example, if the time period used (e.g., required) to change the power usage ratio is to be shortened, the power allocation correction factor K1 may be reduced to be calibrated, and if not, the power allocation correction factor K1 may be increased to be calibrated.

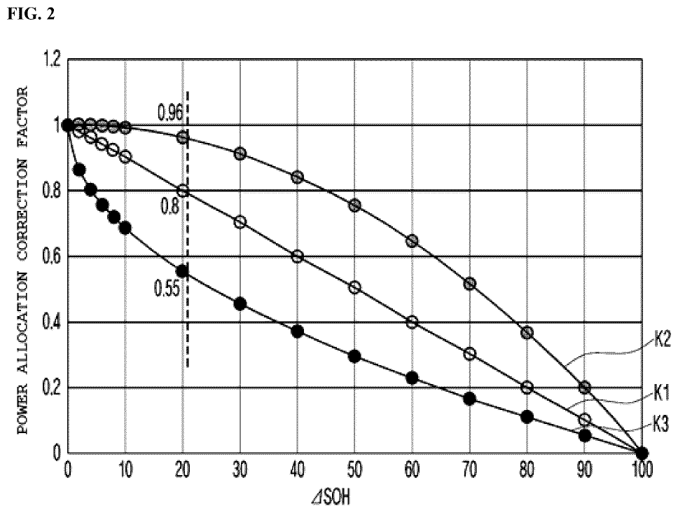

FIG. 2 is a graph of calibration of the power allocation correction factor K1, in which the horizontal axis represents the SOH difference ΔSOH, and the vertical axis represents the power allocation correction factor.

In FIG. 2, K1 represents an uncalibrated power allocation correction factor (hereinafter referred to as a “linear power allocation correction factor”), K3 represents a power allocation correction factor calibrated by reducing the power allocation correction factor K1 (hereinafter referred to as a “root power allocation correction factor”), and K2 represents a power allocation correction factor calibrated by increasing the power allocation correction factor K1 (hereinafter referred to as a “square power allocation correction factor”).

For example, referring to Table 1 and FIG. 2, when the SOH difference ΔSOH is 20%, the value of the linear power allocation correction factor K1 is 0.8.

However, if the time period used (e.g., required) to change the power usage ratio is to be shortened, the linear power allocation correction factor K1 may be calibrated to the root power allocation correction factor K3, so that power allocation may be changed rapidly (e.g., and radically). If not, the linear power allocation correction factor K1 may be calibrated to the square power allocation correction factor K2, so that power allocation may be changed at a relatively low speed.

For example, referring to FIG. 2 and Table 1, when the SOH difference ΔSOH is 20%, the linear power allocation correction factor K1 may be selected as 0.8 using Table 1, may be calibrated to the root power allocation correction factor K3 of 0.55, or may be calibrated to the square power allocation correction factor K2 of 0.96.

The predetermined power allocation ratio may be corrected as shown in Equation 3 below using the calibrated power allocation correction factor CK (step 140).

$$CAR = CK \times AR \qquad [ Equation 3 ]$$

In Equation 3, CK is the calibrated power allocation correction factor, which corresponds to, for example, K2 or K3 shown in FIG. 2.

As described herein, the predetermined power allocation ratio may be corrected using the power allocation correction factors K1, K2, and K3 (step 140).

After step 140, power corresponding to the corrected power allocation ratio is supplied to a load from each of the battery and the cell stack (step 150).

Table 2 is an example of a power allocation map representing the power allocation ratio for each total power TP and each state of charge (SOC) of the battery.

Table 3 is an example of a power allocation map of the corrected power allocation ratio for each total power TP and each state of charge (SOC) of the battery.

Referring to the power allocation maps in Tables 2 and 3, the higher the state of charge of the battery, the lower the power allocation ratio allocated to the cell stack. This provides that, as the state of charge of the battery increases, the battery is used more than the cell stack. Conversely, this provides that, as the state of charge of the battery decreases, the cell stack is used more than the battery.

The predetermined power allocation ratio shown in Table 2 may be corrected using the power allocation correction factor, as shown in Table 3 by performing step 140.

In an example embodiment, according to the embodiment shown in FIG. 1, it is provided (e.g., assumed) that the first SOH SOHI is 70%, the second SOH SOH2 is 90%, the state of charge (SOC) of the battery is 80, the total power TP is 60 kW, and the predetermined power allocation ratio is set as shown in Table 2 above.

Thus, the SOH difference ΔSOH is 20%, and the linear power allocation correction factor K1 selected from Table 1 is 0.8. Referring to Table 2, when the state of charge (SOC) of the battery is 80 and the total power TP is 60 kW, the predetermined power allocation ratio is 0.33.

As shown in Equation 4 below, if the predetermined power allocation ratio of 0.33 is corrected using the linear power allocation correction factor K1 of 0.8 without performing calibration, the corrected power allocation ratio becomes 0.26.

$$0.33 \times 0.8 = 0.26 \qquad [ Equation 4 ]$$

Thus, 0.33 in Table 2 may be updated to 0.26 by performing step 140, as shown in Table 3.

In the example embodiment, because the total power is 60 kW, first power of 15.6 kW, which is the product of 0.26 and 60 KW, may be output to the load from the cell stack, and second power of 44.4 kW, which is obtained by subtracting the first power of 15.6 kW from the total power of 60 kW, may be output to the load from the battery.

That is, if the predetermined power allocation ratio is not corrected using the linear power allocation correction factor K1, first power of 19.8 kW, which is the product of 0.33 and the total power of 60 kW, is output to the load from the cell stack, and second power of 40.2 kW, which is obtained by subtracting the first power of 19.8 kW from the total power of 60 KW, is output to the load from the battery. However, according to the example embodiment, if the second SOH is greater than the first SOH, the first power supplied from the cell stack to the load may be reduced by 4.2 kW, and the second power supplied from the battery to the load may be increased by 4.2 kW, (e.g., substantially) equivalent to an amount of power by which the first power is reduced.

In addition, when the linear power allocation correction factor K1 is calibrated to the square power allocation correction factor K2, and when the predetermined power allocation ratio of 0.33 is corrected using the square power allocation correction factor K2 of 0.96, the corrected power allocation ratio becomes 0.32, as shown in Equation 5 below.

$$0.33 \times 0.96 = 0.32 \qquad [ Equation 5 ]$$

Thus, in the example embodiment, because the total power is 60 kW, first power of 19.2 kW, which is the product of 0.32 and 60 kW, may be output to the load from the cell stack, and second power of 40.8 kW, which is obtained by subtracting the first power of 19.2 kW from the total power of 60 kW, may be output to the load from the battery.

In addition, as shown in FIG. 2, when the linear power allocation correction factor Kl is calibrated to the root power allocation correction factor K3, and when the predetermined power allocation ratio of 0.33 is corrected using the root power allocation correction factor K3 of 0.55, the corrected power allocation ratio becomes 0.18, as shown in Equation 6 below.

$$0.33 \times 0.55 = 0.18 \qquad [ Equation 6 ]$$

Thus, in the example embodiment, because the total power is 60 kW, first power of 10.8 kW, which is the product of 0.18 and 60 kW, may be output to the load from the cell stack, and second power of 49.2 kW, which is obtained by subtracting the first power of 10.8 kW from the total power of 60 kW, may be output to the load from the battery.

As described herein, when the power allocation correction factor is calibrated to a smaller value in FIG. 2, the power usage ratio of the cell stack, which is more degraded among the cell stack and the battery, may be reduced, and the power usage ratio of the battery, which is less degraded among the cell stack and the battery, may be increased.

Herein, the configuration and operation of a fuel cell vehicle according to an example embodiment is described with reference to the accompanying drawings.

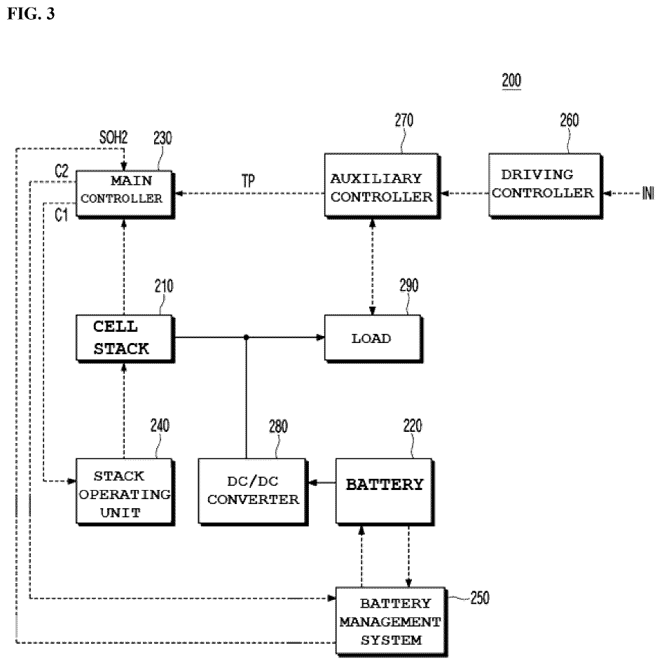

FIG. 3 is a block diagram of a fuel cell vehicle 200 according to an embodiment. In FIG. 3, the dotted lines represent the flow of signals, and the solid lines represent the flow of power.

The method 100 shown in FIG. 1 may be performed in the fuel cell vehicle 200 shown in FIG. 3, but the embodiments are not limited thereto. In an example embodiment, the power allocation method 100 shown in FIG. 1 may be performed in a fuel cell vehicle configured differently from the fuel cell vehicle 200 shown in FIG. 3, and the fuel cell vehicle 200 shown in FIG. 3 may perform a power allocation method configured differently from the power allocation method 100 shown in FIG. 1.

The fuel cell vehicle 200 shown in FIG. 3 may include a cell stack 210, a battery 220, and a main controller 230. In addition, the fuel cell vehicle 200 may further include a stack operating unit 240 and a battery management system 250. In addition, the fuel cell vehicle 200 may further include a driving controller 260, an auxiliary controller 270, a direct current/direct current (DC/DC) converter 280, and a load 290.

The fuel cell may include a plurality of unit fuel cells stacked in at least one of a vertical direction or a horizontal direction. The unit fuel cell may be a polymer electrolyte membrane fuel cell or a proton exchange membrane fuel cell (PEMFC), which may be a power source for driving the fuel cell vehicle 200. However, the embodiments are not limited to any specific configuration or external appearance of the unit fuel cell.

The unit fuel cell included in the fuel cell may include end plates (or pressing plates or compression plates), current collectors, and a cell stack 210.

The cell stack 210 may include a plurality of unit cells stacked in the horizontal direction. Several tens to several hundreds of unit cells, e.g., 100 to 400 unit cells, may be stacked to form the cell stack. The number of unit fuel cells included in the fuel cell and the number of the plurality of unit cells included in the cell stack 210 of the unit fuel cell may be determined depending on the intensity of the power to be supplied from the fuel cell to the load 290.

The end plates may be disposed at respective ends of the cell stack 210 to support (e.g., and fix) the plurality of unit cells. In an example embodiment, one of the end plates may be disposed at one of the two opposite ends of the cell stack 210, and the other of the end plates may be disposed at the other of the two opposite ends of the cell stack 210.

In addition, the fuel cell may further include a clamping member configured to clamp the plurality of unit cells in the form of a bar, a long bolt, a belt, or a rigid rope. For example, in each unit fuel cell, the clamping member serves to clamp the plurality of unit cells in the horizontal direction together with the end plates.

The battery 220 serves to store power.

The stack operating unit 240 serves to output first power corresponding to the corrected power allocation ratio from the cell stack 210 in response to a first control signal C1.

The battery management system 250 performs control in response to a second control signal C2 such that second power, which may be obtained by subtracting the first power from the total power TP used (e.g., required) by the fuel cell vehicle, is output from the battery 220.

In addition, the battery management system 250 may obtain the second SOH SOH2 of the battery 220 using the current and voltage of the battery 220. That is, the battery management system 250 serves to perform step 110 shown in FIG. 1.

The driving controller 260 may measure driving power (e.g., traveling force) used (e.g., required) for the fuel cell vehicle 200. For example, when the user of the fuel cell vehicle 200 depresses the accelerator pedal, the driving controller 260 receives information about this operational situation through an input terminal IN1, measures driving power used (e.g., required) for the fuel cell vehicle 200, and provides information about the measured driving power to the auxiliary controller 270.

The auxiliary controller 270 may calculate total power TP used (e.g., required) to drive the load 290 so that the driving power measured by the driving controller 260 is reached, and may provide information about the calculated total power TP to the main controller 230.

The load 290 may be driven by power supplied from at least one of the cell stack 210 or the battery 220, and may be driven under the control of the auxiliary controller 270. For example, the load 290 may include a driving motor, but the embodiments are not limited to any specific type of the load 290.

The auxiliary controller 270 is a type of microcontroller unit (MCU), which may issue a driving command such as the torque or revolutions per minute (RPM) of the motor included in the load 290, may estimate the torque of the motor, or may sense the RPM of the motor.

The DC/DC converter 280 serves to convert the level of power output from the battery 220 and output power having the converted level. The DC/DC converter 280 may be, for example, a bidirectional DC/DC converter, but the embodiments are not limited to any specific type of the DC/DC converter 280.

The main controller 230 serves to correct and vary the predetermined power allocation ratio using the power allocation correction factor in which a result of comparing the first SOH SOH1 of the cell stack 210 with the second SOH SOH2 of the battery 220 is reflected. In an example embodiment, the main controller 230 serves to perform steps 120 to 140 shown in FIG. 1 and control the stack operating unit 240 and the battery management system 250 so that step 150 is performed.

As described herein, in the power allocation method 100 according to the embodiment, each of the predetermined power allocation ratio and the corrected power allocation ratio represents the power usage ratio of at least one of the cell stack 210 or the battery 220. Herein, each of the predetermined power allocation ratio and the corrected power allocation ratio will be described as representing a ratio of the first power to be output from the cell stack 210 to the total power TP used (e.g., required) by the fuel cell vehicle 200.

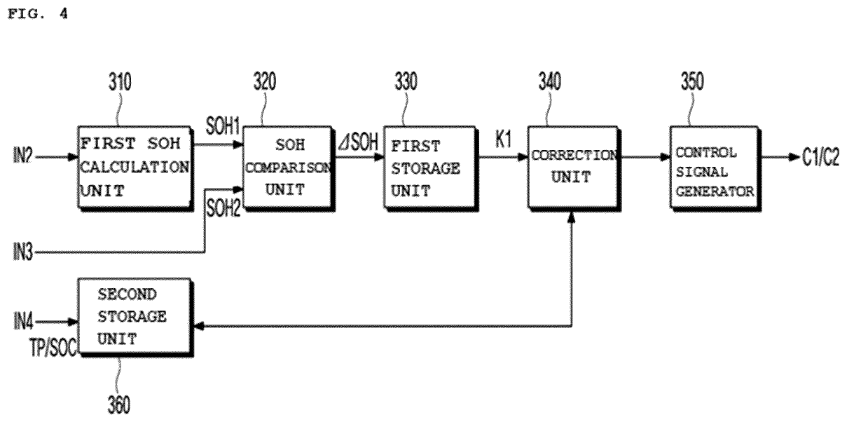

FIG. 4 is a block diagram showing an embodiment of the main controller 230, referred to here as 230A, shown in FIG. 3. The main controller 230A may include a first SOH calculation unit 310, an SOH comparison unit 320, a first storage unit 330, a correction unit 340, a control signal generator 350, and a second storage unit 360. At least one of the first storage unit 330 or the second storage unit 360 may not be a component of the main controller 230 (230A), and the embodiments may not be limited as to the position of the first storage unit 330 or the second storage unit 360 or the presence or absence thereof.

The first SOH calculation unit 310 may obtain the first SOH SOHI of the cell stack 210 using the current and voltage of the cell stack 210 received through an input terminal IN2, and may output the obtained first SOH SOHI to the SOH comparison unit 320. That is, the first SOH calculation unit 310 serves to perform step 110 shown in FIG. 1.

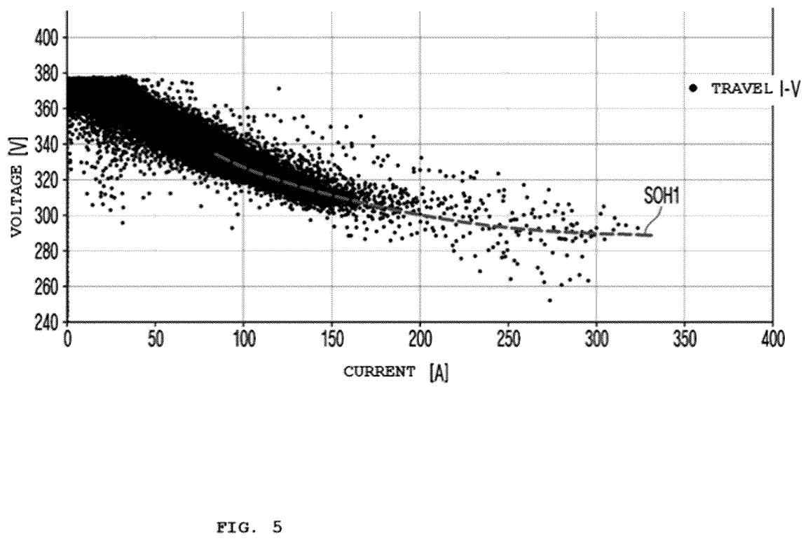

FIG. 5 is a graph illustrating a method of obtaining the first SOH, in which the horizontal axis represents current and the vertical axis represents voltage.

As shown in FIG. 5, changes in the voltage V and the current I of the cell stack 210, which has characteristics in which there is a (e.g., large) fluctuation in performance during travel of the fuel cell vehicle 200, in accordance with the travel distance of the fuel cell vehicle are expressed as dots, and the first SOH SOH1, which is expressed as a line, may be obtained from (e.g., by performing) data processing on the voltage V and the current I of the cell stack 210.

Thus, the battery management system 250 described above may obtain the second SOH SOH2.

The SOH comparison unit 320 subtracts the first SOH SOH1, obtained by the first SOH calculation unit 310, from the second SOH SOH2, received from the battery management system 250 through an input terminal IN3, and outputs a result of the subtraction, e.g., an SOH difference ΔSOH, to the first storage unit 330. The SOH comparison unit 320 serves to perform step 120 shown in FIG. 1.

The first storage unit 330 stores a power allocation correction factor preset for each SOH difference ΔSOH. For example, the first storage unit 330 may store the factor map shown in Table 1.

The first storage unit 330 may read out a linear power allocation correction factor K1 corresponding to the SOH difference ΔSOH output from the SOH comparison unit 320, and may output the linear power allocation correction factor K1 to the correction unit 340. Thus, step 130 shown in FIG. 1 may be performed.

The correction unit 340 corrects a predetermined power allocation ratio, e.g., a ratio of power to be output from each of the battery 220 and the cell stack 210 to the total power, using the linear power allocation correction factor K1 corresponding to the SOH difference ΔSOH, and outputs the corrected power allocation ratio to the control signal generator 350. The correction unit 340 may perform step 140 shown in FIG. 1.

Thus, the second storage unit 360 may store a power allocation map representing a predetermined power allocation ratio for the total power TP, received from the auxiliary controller 270 through an input terminal IN4, and each SOC of the battery 220, received from the battery management system 250.

For example, the second storage unit 360 may store the predetermined power allocation ratio shown in Table 2 above, and may store the corrected power allocation ratio shown in Table 3 above.

In an example embodiment, the correction unit 340 may read out the predetermined power allocation ratio shown in Table 2 from the second storage unit 360, may correct the predetermined power allocation ratio, and may update the power allocation map stored in the second storage unit 360 using the corrected power allocation ratio. As described above, the correction unit 340 may update Table 2 to Table 3, and may store updated Table 3 in the second storage unit 360.

The control signal generator 350 may generate first and second control signals C1 and C2 corresponding to the power allocation ratio corrected by the correction unit 340. The control signal generator 350 may perform step 150 shown in FIG. 1. As described herein, the control signal generator 350 may control the stack operating unit 240 using the first control signal C1 so that the first power is output from the cell stack 210. In addition, the control signal generator 350 may control the battery management system 250 using the second control signal C2 so that the second power is output to the DC/DC converter 280 from the battery 220.

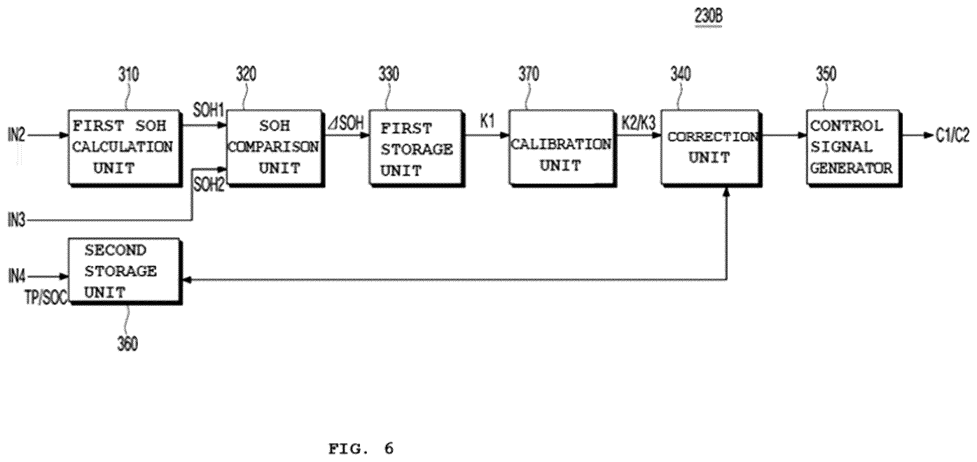

FIG. 6 is a block diagram showing another example embodiment of a main controller 230, referred to as main controller 230B, shown in FIG. 3.

Because the main controller 230B shown in FIG. 6 is the same (or similar) to the main controller 230A shown in FIG. 4 except for further including a calibration unit 370, duplicate descriptions of the same parts will be omitted, and (e.g., only) different parts will be described.

According to another embodiment, the calibration unit 370 calibrates the power allocation correction factor in accordance with a time period used (e.g., required) to change the power usage ratio, and outputs the calibrated power allocation correction factor K2 or K3 to the correction unit 340.

For example, as described above, the power allocation correction factor K1 read out from the first storage unit 330 may be calibrated to K2 or K3 by the calibration unit 370.

It may be seen that, while the correction unit 340 of the main controller 230A shown in FIG. 4 performs correction using the linear power allocation correction factor K1 stored in the first storage unit 330, the correction unit 340 of the main controller 230B shown in FIG. 6 performs correction using the root or square power allocation correction factor (e.g., K3 or K2) calibrated by the calibration unit 370.

Hereinafter, a power allocation method according to a comparative example and the power allocation method according to the embodiment will be described with reference to the accompanying drawings.

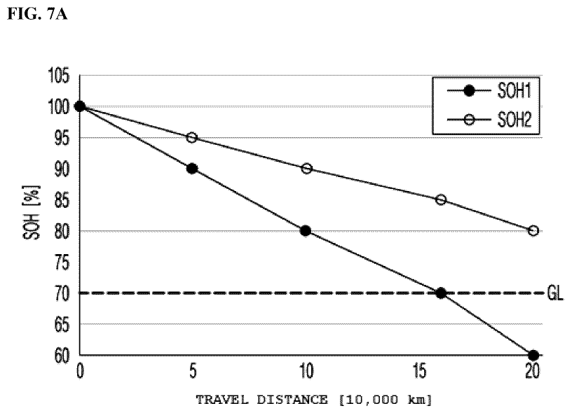

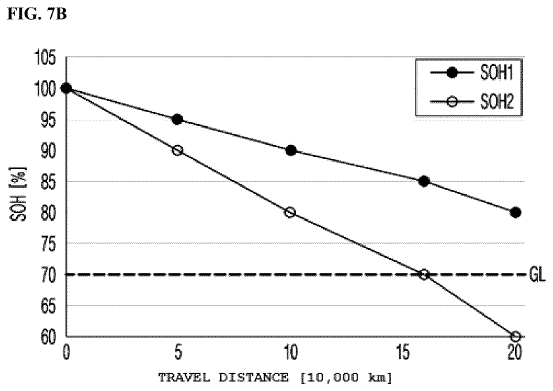

FIGS. 7A and 7B are graphs of the characteristics of a fuel cell vehicle according to the comparative example, in which the horizontal axis represents a travel distance and the vertical axis represents SOH.

The fuel cell vehicle according to the comparative example includes a cell stack and a battery, like the fuel cell vehicle 200 according to the embodiment. If the first SOH SOH1 of the cell stack 210 among the cell stack and the battery reaches 70% when the travel distance of the fuel cell vehicle is 160,000 km, the manufacturer of the fuel cell vehicle replaces the cell stack 210 free of charge.

That is, referring to FIG. 7A, because the first SOH SOHI of the cell stack 210 reaches 70% when the travel distance of the fuel cell vehicle 200 is 160,000 km, the cell stack 210 may be (e.g., needs to be) replaced free of charge. At the time of replacement of the cell stack 210, the second SOH of the battery is 85%, which is greater than 70%. That is, because the second SOH of the battery is sufficient, the battery may not (e.g., does not need to) be replaced.

Alternatively, referring to FIG. 7B, when the second SOH SOH2 of the battery reaches 70% and thus the battery may (e.g., needs) to be replaced, the first SOH SOH1 of the cell stack is 85%, which is greater than 70%. That is, because the first SOH SOH1 of the cell stack is sufficient, the cell stack may not (e.g., does not need to) be replaced.

As shown in FIGS. 7A and 7B, when the SOH of one part among the cell stack and the battery reaches a warranty replacement line GL earlier than the SOH of the other, the corresponding part may (e.g., needs to) be replaced free of charge.

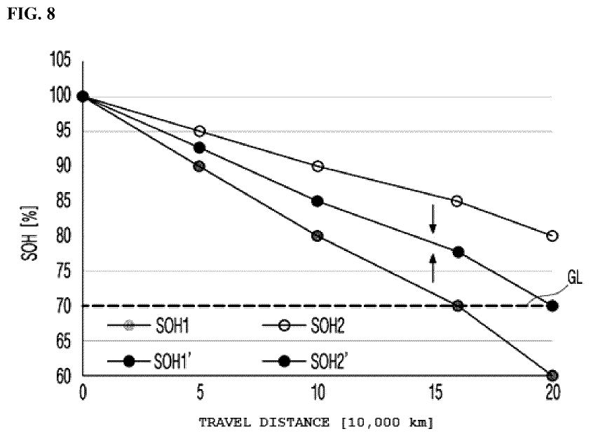

FIG. 8 is a graph of the characteristics of the fuel cell vehicle according to the embodiment, in which the horizontal axis represents a travel distance and the vertical axis represents SOH.

The fuel cell vehicle 200 according to the embodiment performs the power allocation method 100 shown in FIG. 1 to vary the predetermined power allocation ratio, rather than fixing the same, thereby making the first SOH SOH1′ and the second SOH SOH2′ the same (or similar) to each other. For example, at the time point at which the first SOH SOH1 shown in FIG. 7A reaches 70%, the first SOH SOH1′ shown in FIG. 8 is about 78%, which is greater than 70%. In an example embodiment, the second SOH SOH2′ shown in FIG. 8 has a smaller value than the second SOH SOH2 shown in FIG. 7A. It may be seen that, when the method 100 shown in FIG. 1 is performed, the first SOH SOH1 and the second SOH SOH2 converge on SOH1′ and SOH2′, respectively, which are the same or similar to each other, in the directions indicated by the arrows in FIG. 8. Accordingly, compared to the comparative example, the degree of degradation of the battery 220 is increased, and the degree of degradation of the cell stack 210 is reduced so that the degrees of degradation of the cell stack 210 and the battery 220 become (e.g., substantially) equivalent to each other and, as a result, the first SOH SOH1 and the second SOH SOH2 become the same (or similar) to each other. Referring to FIGS. 7A, 7B, and 8, when the travel distance of the fuel cell vehicle of the comparative example and the fuel cell vehicle of the embodiment is 160,000 km, the total amount of power used from the cell stack and power used from the battery in the embodiment is the same (or similar) to that in the comparative example, but the power usage ratio of the battery in the embodiment is higher than in the comparative example.

The SOH may be used as an indicator for a manufacturer of a fuel cell vehicle to provide (e.g., guarantee) the durability of a cell stack and a battery. If the SOH of one part among the cell stack and the battery is less than 70% when the travel distance of the fuel cell vehicle is, for example, 160,000 km, the manufacturer replaces the corresponding part (e.g., free of charge). Considering this, the embodiment may prevent the SOH of one of the cell stack 210 and the battery 220 from reaching the warranty replacement line GL earlier than the SOH of the other, thereby extending the SOH of each of the cell stack 210 and the battery 220. Accordingly, from the perspective of the manufacturer of the fuel cell vehicle, the frequency of free replacement of the cell stack or the battery may be reduced, and as a result, replacement cost may be reduced.

As described above, the embodiment compares the SOH of the cell stack 210 and the SOH of the battery 220 with each other to identify a difference in the degree of degradation therebetween, and increases the power usage ratio of a part, the degree of degradation of which is relatively low, among the cell stack 210 and the battery 220 based thereon. That is, according to the embodiment, when the second SOH SOH2 is greater than the first SOH SOH1, the degree of degradation of the battery 220 is lower than the degree of degradation of the cell stack 210, and thus the power usage ratio of the battery 220 is increased to be greater than that of the cell stack 210, thereby slowing degradation of the cell stack 210. Further, according to the embodiment, when the first SOH SOH1 is greater than the second SOH SOH2, the degree of degradation of the cell stack 210 is lower than the degree of degradation of the battery 220, and thus the power usage ratio of the cell stack 210 is increased to be greater than that of the battery 220, thereby slowing degradation of the battery 220.

In the comparative example, because the predetermined power allocation ratio shown in Table 2 described above is (e.g., fixedly) used, when the degree of degradation of the cell stack and the degree of degradation of the battery are not balanced, it may be difficult to control this unbalanced state. In contrast, according to the embodiment, the predetermined power allocation ratio shown in Table 2 is corrected to the power allocation ratio shown in Table 3 using a result of comparing the first SOH with the second SOH. Therefore, when the degree of degradation of the cell stack 210 and the degree of degradation of the battery 220 are not balanced, it may be possible to control the degree of degradation of the cell stack 210 and the degree of degradation of the battery 220 so that the two degrees of degradation become (e.g., substantially) equivalent to each other.

Accordingly, the SOH of the cell stack 210 and the SOH of the battery 220 are reduced at a similar rate, whereby it may be possible to prevent the SOH of one of the cell stack 210 and the battery 220 from reaching a predetermined lower limit value earlier than the SOH of the other, thereby reducing the frequency of free replacement of the cell stack 210 or the battery 220. As a result, the cost of replacing the cell stack 210 or the battery 220 free of charge may be reduced from the perspective of the manufacturer of the fuel cell vehicle.

In addition, according to the embodiment, if the time period (e.g., required) to change the power usage ratio is to be shortened, the linear power allocation correction factor K1 may be calibrated to the root power allocation correction factor K3 shown in FIG. 2, so that the power usage ratio is changed (e.g., radically). In this way, the power usage ratio of a part that has greatly degraded among the cell stack 210 and the battery 220 is reduced rapidly, so that degradation of the corresponding part is slowed. Accordingly, the SOH difference ΔSOH may converge on 0 in a short time period.

That is, according to the embodiment, the power usage ratios of the cell stack 210 and the battery 220 may be controlled so as to comply with the SOH standards (e.g., requirements) set by the manufacturer of the fuel cell vehicle by calibrating the linear power allocation correction factor. For example, when the manufacturer desires that the SOH of the cell stack 210 and the SOH of the battery 220 are made similar or (e.g., substantially) equivalent to each other (e.g., as quickly as possible), the linear power allocation correction factor shown in FIG. 2 may be calibrated to the root power allocation correction factor, thereby (e.g., more radically) adjusting the power allocation.

According to a fuel cell vehicle and a method of allocating power thereof according to example embodiments herein, when the degree of degradation of a cell stack and the degree of degradation of a battery are not balanced, it may be possible to control the degree of degradation of the cell stack and the degree of degradation of the battery so that the two degrees of degradation become (e.g., substantially) equivalent to each other, thereby minimizing or preventing the SOH of one of the cell stack and the battery from reaching the warranty replacement line earlier than the SOH of the other and thus extending the SOH of each of the cell stack and the battery. Accordingly, from the perspective of the manufacturer of the fuel cell vehicle, the frequency of free replacement of the cell stack or the battery may be reduced, and replacement cost thus may be reduced. Further, the power usage ratios of the cell stack and the battery may be controlled so as to comply with the SOH standards (e.g., requirements) set by the manufacturer of the fuel cell vehicle.

The effects achievable through the disclosure are not limited to the above-mentioned effects, and other effects not mentioned herein may be provided from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been shown and described with reference to exemplary embodiments thereof, these embodiments are (e.g., only) proposed for illustrative purposes, and do not restrict the present disclosure, and it will be apparent that various changes in form and detail may be made without departing from the characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a cell stack including a plurality of stacked unit cells;
a battery; and
a main controller configured to correct and vary a predetermined power allocation ratio using a power allocation correction factor in which a result of comparing a first state of health (SOH) of the cell stack with a second SOH of the battery is reflected,
wherein each of the predetermined power allocation ratio and the corrected power allocation ratio represents a power usage ratio of at least one of the cell stack or the battery.

2. The fuel cell vehicle according to claim 1, wherein each of the predetermined power allocation ratio and the corrected power allocation ratio represents a ratio of first power to be output from the cell stack to total power used by the fuel cell vehicle.

3. The fuel cell vehicle according to claim 2, further comprising:
a stack operating unit configured to output the first power corresponding to the corrected power allocation ratio from the cell stack in response to a first control signal; and
a battery management system configured to perform control in response to a second control signal such that second power obtained by subtracting the first power from the total power is output from the battery,
wherein the main controller generates the first and second control signals in response to the corrected power allocation ratio.

4. The fuel cell vehicle according to claim 3, wherein the battery management system obtains the second SOH of the battery using current and voltage of the battery.

5. The fuel cell vehicle according to claim 4, wherein the main controller includes:
a first SOH calculation unit configured to obtain the first SOH of the cell stack using current and voltage of the cell stack;
an SOH comparison unit configured to subtract the first SOH from the second SOH to obtain an SOH difference;
a first storage unit configured to store a power allocation correction factor for each SOH difference;
a correction unit configured to correct a predetermined power allocation ratio for each SOH difference, representing a ratio of power to be output from each of the battery and the cell stack to the total power, using the power allocation correction factor corresponding to the SOH difference; and
a control signal generator configured to generate the first and second control signals corresponding to the corrected power allocation ratio.

6. The fuel cell vehicle according to claim 5, further comprising a second storage unit configured to store a power allocation map representing the predetermined power allocation ratio for the total power and each state of charge (SOC) of the battery,
wherein the correction unit reads out the predetermined power allocation ratio from the second storage unit, corrects the predetermined power allocation ratio, and updates the power allocation map stored in the second storage unit using the corrected power allocation ratio.

7. The fuel cell vehicle according to claim 5, wherein the main controller further includes a calibration unit configured to calibrate the power allocation correction factor in accordance with a time period to change the power usage ratio.

8. The fuel cell vehicle according to claim 5, wherein the power allocation correction factor used in the correction unit is stored in the first storage unit.

9. The fuel cell vehicle according to claim 7, wherein the power allocation correction factor used in the correction unit corresponds to a result of calibration by the calibration unit.

10. The fuel cell vehicle according to claim 3, further comprising:
a driving controller configured to measure traveling force for the fuel cell vehicle;
an auxiliary controller configured to calculate the total power to drive a load so that the traveling force measured by the driving controller is reached and to provide information about the calculated total power to the main controller; and
a direct current/direct current converter configured to convert a level of power output from the battery and to output power having the converted level.

11. A method of allocating power of a fuel cell vehicle, the method comprising:
obtaining a first SOH of a cell stack;
obtaining a second SOH of a battery;
obtaining an SOH difference by which the second SOH is greater than the first SOH;
obtaining a power allocation correction factor corresponding to the SOH difference;
correcting and varying a predetermined power allocation ratio using the power allocation correction factor; and
supplying power corresponding to the corrected power allocation ratio to a load from each of the battery and the cell stack,
wherein each of the predetermined power allocation ratio and the corrected power allocation ratio represents a power usage ratio of at least one of the cell stack or the battery.

12. The method according to claim 11, wherein each of the predetermined power allocation ratio and the corrected power allocation ratio represents a ratio of power to be output from the cell stack to total power used by the fuel cell vehicle.

13. The method according to claim 12, wherein the SOH difference and the power allocation correction factor are inversely proportional to each other.

14. The method according to claim 11, wherein obtaining the power allocation correction factor includes selecting the power allocation correction factor corresponding to the SOH difference using a factor map representing a power allocation correction factor for each SOH difference.

15. The method according to claim 14, wherein obtaining the power allocation correction factor further includes calibrating the power allocation correction factor selected from the factor map in accordance with a time period to change the power usage ratio.

16. The method according to claim 11, wherein the first SOH is a ratio of a current maximum capacity of the cell stack to a maximum capacity at beginning of life of the cell stack, and
wherein the second SOH is a ratio of a current maximum capacity of the battery to a maximum capacity at beginning of life of the battery.
